(19) United States
(12) Patent Application Publication
(10) Pub. No.: US 2012/0097609 A1
(43) Pub. Date: Apr. 26, 2012

(54) METHODS AND SYSTEMS FOR TREATMENT OF AQUEOUS OILY SOLUTIONS

(76) Inventors: Jiyang Xia, Shanghai (CN); Wei Cai, Shanghai (CN); Rihua Xiong, Shanghai (CN); Yiwen Sun, Shanghai (CN); Chunjie Liu, Shanghai (CN); George Randall Jones, Renton, WA (US); William Fred Heins, Redmond, WA (US)

(21) Appl. No.: 13/275,485

(22) Filed: Oct. 18, 2011

(30) Foreign Application Priority Data
Oct. 22, 2010 (CN) 201010526996.1

(51) Int. Cl. C02F 1/40; C02F 1/52; B01D 21/00; C02F 1/00; B01D 11/04; B01D 17/02

(52) U.S. Cl. 210/638; 210/634; 210/205; 210/199; 210/202

(57) ABSTRACT

A method for treatment of an aqueous oily solution includes combining the aqueous oily solution with one or more miscible organic solvents to produce a mixture of precipitated solids and a liquid phase; separating the precipitated solids from the liquid phase; separating the liquid phase at least into an organic phase and an aqueous phase; and removing at least a portion of one or more oily substances from the organic phase. A system for treatment of an aqueous oily solution is also presented.

### BACKGROUND

The disclosure generally relates to a water treatment technology, and more particularly to methods and systems for treatment of aqueous oily solutions.

With the development of economic, large amount of wastewaters are produced during industrial processes. The industrial wastewaters generally contain harmful or toxic substances such as oil, grease, heavy metals as well as high levels of salts. In view of protection of environments and limited eligible water sources, the industrial wastewaters are required to be treated to satisfy discharge standards or recovery the water therein. Currently, there are many ways to treat the industrial wastewaters in different industrial fields.

Steam assisted gravity drainage (SAGD) is one technology for oil sands extraction and heavy oil recovery. The wastewater produced in SAGD process contains large amount of salts, oil and grease. One way to treat the SAGD wastewater is to use a thermal evaporator, for example, a falling film evaporator with a mechanical vapor compressor, to recover most of the water and output a concentrated brine stream.

Although the volume of the SAGD brine stream from the evaporator is much less than the original wastewater, for example, only about 5% of the original wastewater, it contains high concentration of oil and grease. These oil and grease generally have high boiling points (over 100 Celsius degrees). It is not efficient for a thermal crystallizer, which is typically used to treat the SAGD brine stream from an thermal evaporator when a raw water contains little oil and grease, to further treat this oily brine since the oil and grease will coat on solid salts and prevent the forming of a dry solid output that is suitable for transportation and landfill.

Therefore, there is a need for new and improved methods and systems for treatment of SAGD wastewater or other kinds of aqueous oily solutions.

### BRIEF DESCRIPTION

In accordance with one embodiment, a method for treatment of an aqueous oily solution comprises combining the aqueous oily solution with one or more miscible organic solvents to produce a mixture of precipitated solids and a liquid phase; separating the precipitated solids from the liquid phase; separating the liquid phase at least into an organic phase and an aqueous phase; and removing at least a portion of one or more oily substances from the organic phase.

In accordance with another embodiment, a method for treatment of a brine stream from a thermal evaporator treating an SAGD wastewater comprises combining the brine stream with one or more miscible organic solvents to produce a mixture of precipitated solids and a liquid phase; separating the precipitated solids from the liquid phase; separating the liquid phase into an organic phase and an aqueous phase; removing at least a portion of one or more oily substances from the organic phase; and removing at least a portion of one or more residual miscible organic solvents and at least a portion of one or more oily substances from the aqueous phase.

In accordance with a further embodiment, a system for treatment of an aqueous oily solution comprises a precipitation device, a liquid-liquid separation device and a de-oil device. The precipitation device is configured to combine the aqueous oily solution with one or more miscible organic solvents to produce a mixture of precipitated solids and a liquid phase. The liquid-liquid separation device is in fluid communication with the precipitation device and configured to separate the liquid phase into at least an organic phase and an aqueous phase. The de-oil device is in fluid communication with the liquid-liquid separation device and configured to remove at least a portion of one or more oily substances from the organic phase.

These and other advantages and features will be further understood from the following detailed description of embodiments of the invention that are provided in connection with the accompanying drawings.

### BRIEF DESCRIPTION OF THE DRAWINGS

FIG. 1 is a schematic diagram of a system for treatment of an aqueous oily solution in accordance with one embodiment; and

FIG. 2 is a schematic flow chart of a method for treatment of an aqueous oily solution in accordance with one embodiment.

### DETAILED DESCRIPTION

Embodiments of the present disclosure will be described herein with reference to the accompanying drawings. In the following description, well-known functions or constructions are not described in detail to avoid obscuring the disclosure in unnecessary detail.

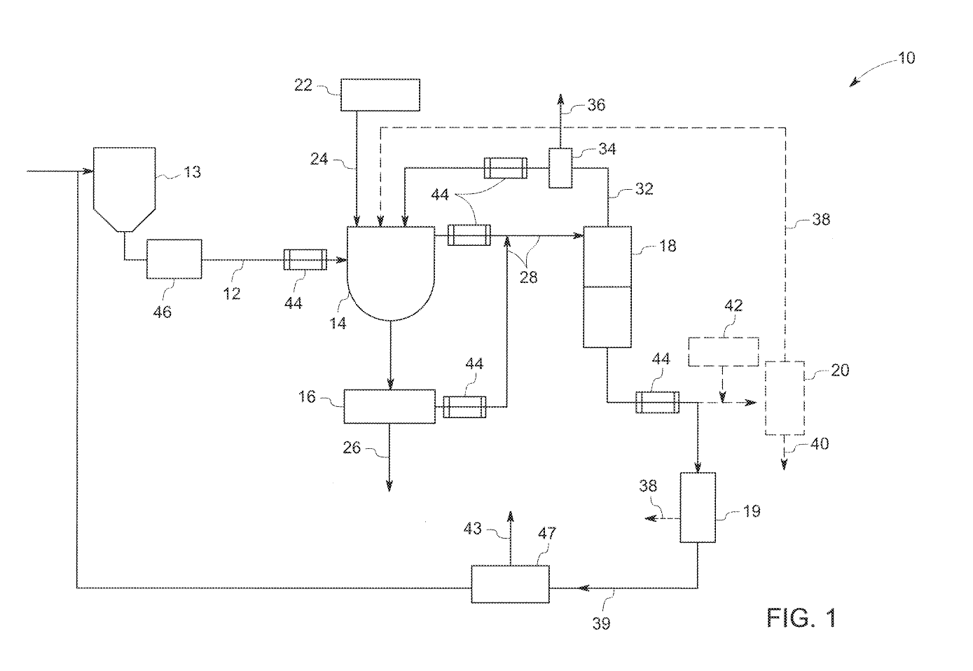

FIG. 1 is a schematic diagram of a system 10 for treatment of an aqueous oily solution 12. The aqueous oily solution 12 indicates a saline solution containing oil and grease or other kinds of oily substances. The aqueous oily solution 12 contains a certain amount of salts species therein. The salt species include salts selected from the group consisting of halides of sodium, calcium, barium, strontium, and radium, bicarbonates of sodium, potassium, magnesium, calcium, barium, strontium, and radium, silicates of sodium, potassium, magnesium, and radium, selenites, selenates, selenides of sodium, potassium, magnesium, calcium, barium, strontium, and radium, selenide salts selected from the group consisting of phosphorous sub-selenide, phosphorous monoselenide, phosphorous tri-selenide, and phosphorous penta-selenide, selenium halide salts selected from the group consisting of selenium mono-chloride, selenium tetra-chloride, selenium mono-bromide, and selenium tetra-bromide, phosphates of sodium, potassium, magnesium, calcium, barium, strontium, and radium, boron salts of sodium, potassium, magnesium, calcium, barium, strontium, and radium, sulfate salts of sodium, potassium and radium, carbonate salts of sodium, potassium and magnesium, and combinations thereof.

In one example, the aqueous oily solution 12 is blown down from a thermal evaporator 13. In another example, the aqueous oily solution 12 is a waste stream from an SAGD process (referred to as “SAGD wastewater”) that contains 2˜3-weight percent (2 wt %˜3 wt %) oily substances, 25 wt % total dissolved solids (TDS) and 3 wt % silica. After an evaporation process in a thermal evaporator such as 13 according to one application, the concentration of the oily substances, TDS and silica in the SAGD wastewater become higher.

Referring to FIG. 1, the system 10 is configured to perform the treatment, such as precipitation of the salt species in the aqueous oily solution 12 via using one or more miscible organic solvents to reduce concentrations of the salt species. The term “miscible organic solvent” indicates any organic solvent that is miscible with water under one or more conditions and can be at least partially separated from water via one or more processes or under one or more conditions.

The miscible organic solvents may be selected based on different applications. In one example, the miscible organic solvents may be amines such as diisopropylamine and triethylamine. The amines are miscible with water at a lower temperature such as about 0 Celsius degree and separated from water at a higher temperature such as about 74 Celsius degrees.

In another example, the miscible organic solvents may be alcohols such as 3-methyl-1-butanol, cyclohexanol, 3-pentanol, 1-hexanol, 1-pentanol, 2-octanol and 2-ethyl hexanol. The alcohols are miscible with water at a higher temperature such as about 85 Celsius degrees and separated from water at a lower temperature such as about 20 Celsius degrees. In a further example, the miscible organic solvents may be ketones such as methyl ethyl ketone (MEK), methyl isobutyl ketone (MIBK) and cyclopentanone. The ketones are miscible with water at a higher temperature such as about 70 Celsius degrees and separated from water at a lower temperature such as about 20 Celsius degrees, which shows similar property as the alcohols in terms of water miscibility. In certain embodiments, the miscible organic solvents are selected from amines, alcohols and ketones that have 4˜8 carbon atoms.

Referring to FIG. 1, the system 10 includes a precipitation device 14, a solid-liquid separation device 16 and a liquid-liquid separation device 18 and a purification device. The system 10 according to one embodiment further includes an organic solvent source 22 for providing a miscible organic solvent 24 that can dissolve at least a portion of oily substances in the precipitation device 14.

The precipitation device 14 is configured to accommodate the aqueous oily solution 12 and the organic solvent 24. In one embodiment, the precipitation device 14 is a crystallizer. It should be noted that the conditions of the precipitation device 14 such as temperature are variable and predetermined according to the property of the selected miscible organic solvent 24. In one embodiment, the miscible organic solvent 24 is diisopropylamine, and the temperature of the precipitation device 14 is set to about 0° C. (Celsius degrees). In another embodiment, the miscible organic solvent 24 is cyclohexanol, and accordingly the temperature of the precipitation device 14 is set to about 85° C.

In one application, the aqueous oily solution 12 and the miscible organic solvent 24 are combined with each other within the precipitation device 14 such that one or more dissolved species such as sodium chloride and silica in the aqueous oily solution 12 are precipitated or crystallized out via a precipitation process or a crystallization process, thereby forming a mixture of precipitated solids 26 and a liquid phase 28 in the precipitation device 14. According to one example, most of the precipitated solids 26 are solid salts. It is understood that the liquid phase 28 is referred to as “mother liquid” in some applications.

The solid-liquid separation device 16 is in fluid communication with the precipitation device 14 for receiving and separating the precipitated solids 26 and the liquid phase 28. The solid-liquid separation device 16 is not limited to any particular device suitable for separation of the precipitated solids 26 and the liquid phase 28. The solid-liquid separation device 16 in one embodiment includes one or more hydrocyclones, one or more centrifuges, one or more filter presses, one or more cartridge filters, one or more vacuum filtration devices or combinations thereof. In another embodiment, there are two or more hydrocyclones that are connected in series for separating the precipitated solids 26 and the liquid phase 28.

In the precipitation device 14, at least a portion of the oily substances contained in the aqueous oily solution 12 are dissolved by the miscible organic solvent 24 and become one part of the liquid phase 28, and thus the precipitated solids 26 can be efficiently spilt from the portion of oily substances by a solid-liquid separation and become dry solids. The dry precipitated solids are easy to be transported. Although the precipitated solids are still mixed with a small amount of miscible organic solvents in some applications, heating or other suitable processes may be used herein to remove the miscible organic solvents such that the precipitated solids can also satisfy landfill requirements. After removing the precipitated solids, salt concentration in the liquid phase is low, which facilities recovery of the water in the downstream processes.

It should be noted that the arrangement shown in FIG. 1 is merely illustrative. For the illustrated embodiment, the precipitation device 14 and the solid-liquid separation device 16 are provided separately. In an alternative example, the precipitation device 14 and the solid-liquid separation device 16 are integrated to act as one element for performing the precipitation and the separation.

The liquid-liquid separation device 18 is in fluid communication with the solid-liquid separation device 16 and/or the precipitation device 14 and configured to receive the liquid phase 28 from the solid-liquid separation device 16 and/or an upper portion (not labeled) of the precipitation device 14. The liquid-liquid separation device 18 is used to facilitate separation of the liquid phase 28, for example, to separate a liquid with different liquid phases.

In some examples, the solid-liquid separation device 16 is not employed, and the liquid phase 28 at the upper portion of the precipitation device 14 is directly introduced into the liquid-liquid separation device 18 after the salt species precipitate to settle down at a lower portion of the precipitation device 14.

In some examples, the liquid-liquid separation device 18 is a vessel, in which the separation of the liquid phase 28 occurs, thereby forming an aqueous phase 30 and an organic phase 32. The separation processes are varied according to the property of the miscible organic solvent 24.

In one embodiment, the miscible organic solvent 24 is diisopropylamine, and the separation of the liquid phase 28 is implemented by heating the liquid phase 28 to a predetermined temperature such as 74° C. In another embodiment, the miscible organic solvent 24 is cyclohexanol, and the separation of the liquid phase 28 is implemented by cooling the liquid phase 28 to a predetermined temperature such as 20° C. In a further embodiment, the liquid-liquid separation device 18 includes one or more membrane distillation devices for separation, so the organic phase 32 is separated from the aqueous phase 30 and recovered.

The organic phase 32 in one embodiment is reintroduced into the precipitation device 14. The organic phase 32 contains the oily substances, so the system 10 further includes a de-oil device 34 to avoid the oily substances from accumulating in the system 10. Any ways for removing the oily substances from the organic phase 32 can be used in the de-oil device 34. In one embodiment, the organic phase 32 is boiled to remove the oily substances 36 and recover the miscible organic solvent 24 because of their boiling points gap therebetween.

In certain applications, a portion of the miscible organic solvent is residual in the aqueous phase 30 after the separation in the liquid-liquid separation device 18. Accordingly, in order to recover the residual miscible organic solvent 38 and enable the aqueous phase 30 to be recovered or satisfy the discharge standards, the aqueous phase 30 from the liquid-liquid separation device 18 in one embodiment is introduced into the purification device for the separation of the residual miscible organic solvent 38 from the aqueous phase 30.

The purification device may include any devices suitable for the separation of the residual miscible organic solvent 38 from the aqueous phase 30. Because the miscible organic solvent 38 has low boiling point, one embodiment of the purification device 19 is employed to remove the residual miscible organic solvent 38 by steam stripping. The liquid 39 from the purification device may have a small amount of TDS, oily substances or other kinds of water-miscible substances. According to one embodiment, the liquid 39 is recycled back to the thermal evaporator 13 for recovering the water therein. The remaining TDS and oily substances along with the aqueous oily solution 12 go to the system 10 for further treatment.

In some applications, the system 10 may further includes another de-oil device 47 for removing one or more water-miscible oily substances 43 that may be contained in the aqueous phase 30. In one example, the liquid 39 is discharged from the purification device 19 and then goes to the de-oil device 47. According to one example, the de-oil device 47 employs demulsifier to remove at least a portion of water-miscible oily substances 43. It is understood that the de-oil device 47 is not limited to use any particular process.

An alternative embodiment of the purification device 20 is also shown in FIG. 1. The purification device 20 includes one or more membrane devices employing one or more membranes to remove the residual miscible organic solvent 38, and residual oily substances are also removed in some applications. According to one example, the one or more membranes include one or more oil resistant membranes, such as ceramic membrane. The membrane devices include but are not limited to one or more reverse osmosis devices, one or more nanofiltration devices, one or more membrane distillation devices or combinations thereof.

The purification device 20 according to one example produces a product water 40 that may be used in many industrial applications and a concentrated stream containing the residual miscible organic solvent 38 that may be recycled back to the precipitation device 14.

In one embodiment, the purification device 20 includes one or more ion removal devices and the system further includes an ionization source 42 disposed upstream from and in fluid communication with the one or more ion removal devices. The one or more ion removal devices include but are not limited to one or more ion exchange resins, one or more electrodialysis reversal devices, one or more electrodialysis reversal devices, one or more membrane distillation devices, one or more supercapacitor desalination devices or combinations thereof. The one or more ion removal devices may employ oil resistant membranes.

The ionization source 42 is employed for providing one or more ionization materials to ionize at least a portion of the residual miscible organic solvent in the aqueous phase 30. Then, the one or more ion removal devices remove the ionized organic solvent from the aqueous phase 30. The one or more ionization materials include but are limited to one or more pH adjustment materials. The pH of the aqueous phase 30 is reduced in some examples. Suitable pH adjustment materials include but are not limited to hydrochloric acid and sulphuric acid.

In the system 10, the miscible organic solvent 24 is employed to treat the aqueous oily solution 12. In the precipitation device 14, the water and the miscible organic solvent 24 are miscible with each other, and most salt species and/or silica are precipitated or crystallized out to become the precipitated solids 26 due to lower solubility of the dissolved salts in the miscible organic solvent. After the separation of the precipitated solids 26 and the liquid phase 28, the precipitated solids 26 also separate from the at least a portion of oily substances because some of the oily substances are dissolved by the miscible organic solvent 24 and become one part of the liquid phase 28. Therefore, dry and transportable precipitated solids 26 are obtained. In the de-oil device 34, the oily substances 36 are separated from the miscible organic solvent, which enables the miscible organic solvent to be reused in the precipitation device 14 and also avoid the oily substances from accumulation in the system 10.

In certain applications, the system 10 further includes one or more heat-exchanging apparatuses 44 disposed among the precipitation device 14, the solid-liquid separation device 16 and the liquid-liquid separation device 18, and/or the liquid-liquid separation device 18 and the purification device 19, 20 for thermal exchange. In some applications, the liquid-liquid separation device 18 may be integrated with a heat-exchanging apparatus including, but is not limited to a heater.

In some embodiments, the system 10 further includes a de-oil device 46 which is in fluid communication with the precipitation device 14. The de-oil device 46 is employed to remove at least a portion of one or more oily substances before the combination of the aqueous oily solution 12 and the one or more miscible organic solvents in the precipitation device 14.

The following table-1 shows experimental data of samples from the aqueous oily solution 12, the precipitated solids 26 and the aqueous phase 30 according to one example of the system 10. In this example, the miscible organic solvent 24 is diisopropylamine, and accordingly the temperature of the precipitation device 14 is 0° C. Furthermore, the separation of the organic phase 32 and the aqueous phase 30 is implemented by heating the liquid phase 28 to 74° C. in the liquid-liquid separation device 18. In the first column of the table-1, “TDS (180° C.)” means the value of TDS measured at 180° C. and “fixed solids (550° C.) indicates the weight of dissolved solids residual in the aqueous phase 30 that is measured at 550° C.

It can be seen from the table-1 that most of salts species, silica and alkalinity contained in the aqueous oily solution are precipitated out in the precipitation device 14 using the diisopropylamine. Additionally, it is also seen from the fourth column of the table-1 that there is a small amount of TDS, sodium, chloride, silica, alkalinity and oil and grease residual in the aqueous phase 30. In order to minimize the residual substances in the aqueous phase 30, in some embodiments, the system 10 employs the purification device 19 or 20 to remove at least a portion of these residual substances.

TABLE 1

| | Aqueous oily | Dry | Aqueous |
|---|---|---|---|
| | solution | precipitated | phase |
| | (mg/L) | solids (mg/kg) | (mg/kg) |
| TDS (180° C.) | 248,000 | — | 33,300 |
| Fixed Solids (550° C.) | — | — | 17,700 |
| Sodium | 84,600 | 369,000 | 7,400 |
| Chloride | 41,200 | 61,000 | 4,400 |
| Silica | 27,800 | 174,000 | 3,000 |
| Alkalinity (such as CaCO₃) | 117,000 | — | 18,600 |
| Oil & grease | 20,000-30,000 | — | 17,000 |
| pH | 13.8 | — | 11.1 |

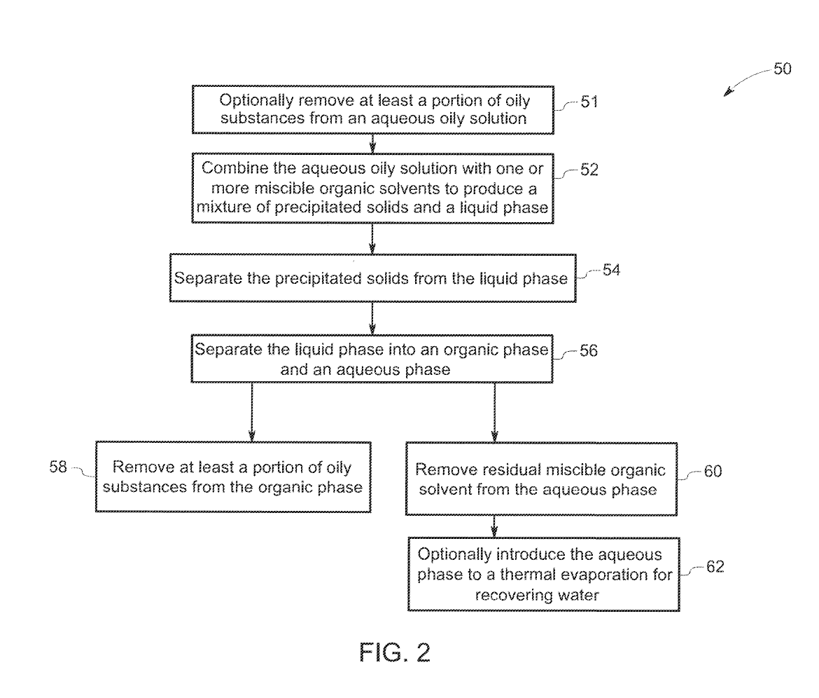

FIG. 2 is a flow chart of a method 50 for treatment of an aqueous oily solution. The method 50 is used for removing at least a portion of TDS, oily substances, silica or other harmful or toxic substances contained in the aqueous oily solution so as to satisfy discharge standards or reuse the water contained in the aqueous oily solution. In one embodiment, the aqueous oily solution is SAGD wastewater that contains 2 wt %˜3 wt % oily substances such as oil and grease therein.

In step 52, the aqueous oily solution is combined with one or more miscible organic solvents in a precipitation device. The one or more miscible organic solvents can dissolve at least a portion of oily substances such as heavy oil. In one embodiment, the aqueous oily solution is blown down from a thermal evaporation and has a high temperature, so the method further includes cooling the aqueous oily solution to a predetermined temperature such as about 0° C. before the step 52. The conditions of the precipitation device such as temperature and precipitation time may be variable according to the property of the one or more miscible organic solvents. In one embodiment, the step 52 is implemented at a higher temperature, such as 85° C. In another embodiment, the step 52 is implemented at a lower temperature, such as 0° C.

A mixture of precipitated solids and a liquid phase is produced during the step 52. The precipitated solids includes a large amount of solid salts or/and other solids. It is should be noted that the process occurred in the precipitation device is not limited to a precipitation process or a crystallization process.

In step 54, the mixture of the precipitated solids and the liquid phase is separated. At least a portion of oily substances are dissolved by the one or more miscible organic solvents and become a part of the liquid phase, thus the precipitated solids can also be separated with some of the oily substances and form dry precipitated solids along with the solid-liquid separation in the step 54. The dry precipitated solids are easy to be transported and discharged. Also, the salt concentration in the liquid phase is efficiently decreased. In some applications, the method 50 further includes heating or vacuum the precipitated solids to get rid of some residual miscible organic solvents thereon such that the dry precipitated solids meets the landfill requirements.

In one embodiment, the separation of the precipitated solids and the liquid phase is implemented by directly removing the liquid from upper portion of the precipitation device. In another embodiment, a device such as a hydrocyclone, a centrifuge, a filter press, a cartridge filter, vacuum filtration device or combinations thereof performs the separation of the precipitated solids and the liquid phase.

In step 56, the liquid phase is separated into an organic phase and an aqueous phase in a liquid-liquid separation device. In one embodiment, the one or more miscible organic solvents include diisopropylamine, and the separation of the liquid phase is implemented by heating the liquid phase to a predetermined temperature such as 74° C. In another embodiment, the one or more miscible organic solvents include cyclohexanol, and the separation of the liquid phase is implemented by cooling the liquid phase to a predetermined temperature such as 20° C.

In step 58, at least a portion of the oily substances dissolved in the one or more miscible organic solvents is removed such that the miscible organic solvents may be reused in the step 52, which not only avoids the accumulation of the oily substances in the whole process but also improves the usage efficiency of the miscible organic solvents. According to one embodiment, boiling the organic phase according to boiling points gap between the oily substances and the miscible organic solvents performs their separation.

In step 60, some residual miscible organic solvent in the aqueous phase is removed and recovered. In one embodiment, the residual miscible organic solvent is removed by extraction or/and thermal distillation. In another embodiment, one or more membrane devices are employed to remove the residual miscible organic solvent, and also remove residual oily substances in some applications. The one or more membrane devices according to one embodiment employ oil resistant membrane such as ceramic membrane.

In a further embodiment, a certain amount of the pH adjustment materials are employed to adjust the pH of the aqueous phase before the step 60. In an example of the step 60, the ionized organic solvents are removed by one or more ion removal devices such as an ion exchange resin, a reverse osmosis device, an electrodialysis reversal device, a membrane distillation device, a supercapacitor desalination device or combinations thereof.

In certain embodiments, the method 50 further includes removing some water-miscible oily substances from the aqueous phase before discharging or recovering the aqueous phase. One example of the removal of the water-miscible oily substances is using one or more demulsifiers.

According to one example, the method 50 further includes an optional step 62. The step 62 is implemented after removing the residual miscible organic solvents. In the step 62, the aqueous phase is introduced into a thermal evaporation for recovering water contained in the aqueous phase.

According to another example, the method 50 further includes another optional step 51. In step 51, at least a portion of one or more oily substances are removed by a chemical process such as using one or more demulsifiers, which separate the oily substances from the aqueous oily solution and makes the treatment in the following steps easier.

In other applications, one or more heat exchanging steps, one or more heating steps or one or more cooling steps may be employed before the steps 52, 56, 58 and 60.

It should be noted that “a” and “an” used to modify uncountable term herein are intended to specially indicate the term is first mentioned in individual sections rather than limit the term's amount.

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. A method for treatment of an aqueous oily solution, the method comprising:
combining the aqueous oily solution with one or more miscible organic solvents to produce a mixture of precipitated solids and a liquid phase;
separating the precipitated solids from the liquid phase;
separating the liquid phase at least into an organic phase and an aqueous phase; and
removing at least a portion of one or more oily substances from the organic phase.

2. The method of claim 1, further comprising removing at least a portion of one or more residual miscible organics solvents from the aqueous phase.

3. The method of claim 2, wherein the removal of the portion of one or more residual miscible organics solvents from the aqueous phase is implemented by steam stripping.

4. The method of claim 1, further comprising removing at least a portion of one or more oily substances from the aqueous phase by one or more demulsifiers.

5. The method of claim 1, further comprising introducing the aqueous phase into a thermal evaporator.

6. The method of claim 1, further comprising introducing one or more ionization materials into the aqueous phase to ionize at least a portion of the one or more miscible organic solvents residual in the aqueous phase; and removing the ionized miscible organic solvents using one or more of ion removal devices.

7. The method of claim 1, wherein separating the liquid phase at least into an organic phase and an aqueous phase is implemented by heating or cooling the liquid phase to a predetermined temperature.

8. The method of claim 1, further comprising introducing the organic phase to combine with the aqueous oily solution after the removal of the at least a portion of one or more oily substances from the organic phase.

9. The method of claim 1, wherein removing at least a portion of one or more oily substances from the organic phase comprises boiling the organic phase.

10. The method of claim 1, wherein the one or more miscible organic solvents are selected from one of amines, alcohols and ketones that have 4 to 8 carbon atoms.

11. The method of claim 1, further comprising removing at least a portion of one or more oily substances from the aqueous oily solution before the combination of the aqueous oily solution and the one or more miscible organic solvents.

12. A method for treatment of a brine stream from a thermal evaporator treating an SAGD wastewater, the method comprising:
combining the brine stream with one or more miscible organic solvents to produce a mixture of precipitated solids and a liquid phase;
separating the precipitated solids from the liquid phase;
separating the liquid phase into an organic phase and an aqueous phase;
removing at least a portion of one or more oily substances from the organic phase; and
removing at least a portion of one or more residual miscible organic solvents and at least a portion of one or more oily substances from the aqueous phase.

13. The method of claim 12, further introducing the aqueous phase back to the thermal evaporator after the removal of the portion of residual miscible organic solvents and the portion of oily substances from the aqueous phase.

14. The method of claim 12, further comprising removing at least a portion of one or more oily substances from the brine stream before the combination of the brine stream and the one or more miscible organic solvents.

15. A system for treatment of an aqueous oily solution, the system comprising:
a precipitation device configured to combine the aqueous oily solution with one or more miscible organic solvents to produce a mixture of precipitated solids and a liquid phase;
a liquid-liquid separation device in fluid communication with the precipitation device and configured to separate the liquid phase into at least an organic phase and an aqueous phase; and
a de-oil device in fluid communication with the liquid-liquid separation device and configured to remove at least a portion of one or more oily substances from the organic phase.

16. The system of claim 15, comprising a purification device that is fluid communication with the liquid-liquid separation device and configured to remove at least a portion of one or more residual miscible organic solvents and/or at least a portion of one or more oily substances from the aqueous phase.

17. The system of claim 16, wherein the purification device comprises one or more membrane devices.

18. The system of claim 17, wherein the one or more membrane devices comprise one or more oil resistant membranes.

19. The system of claim 16, wherein the purification device comprises one or more ion removal devices and the system further comprises an ionization source that is fluid communication with an upstream position of the one or more ion removal devices and configured to provide one or more ionization materials to ionize the portion of the one or more residual miscible organic solvents in the aqueous phase.

20. The system of claim 15, comprising a solid-liquid separation device that is fluid communication with the precipitation device and configured to separate the precipitated solids from the liquid phase.

21. The system of claim 15, wherein the de-oil device is configured to be boiled to remove the portion of the one or more oily substances from the organic phase.

22. The system of claim 15, wherein the aqueous oily solution comprises an SAGD wastewater that has 2 wt %˜3 wt % oily substances.

23. The system of claim 15, wherein the aqueous oily solution is a brine stream from a thermal evaporator treating an SAGD wastewater.

24. The system of claim 15, further comprises another de-oil device that is in fluid communication with the precipitation device and configured to remove at least a portion of one or more oily substances from the aqueous oily solution.
